(19) United States
(12) Patent Application Publication
(10) Pub. No.: US 2011/0126171 A1
(43) Pub. Date: May 26, 2011

(54) DYNAMIC NATIVE EDITOR CODE VIEW FACADE

(75) Inventors: Adam R. Neal, Ottawa (CA); Steven R. Shaw, Ottawa (CA)

(73) Assignee: INTERNATIONAL BUSINESS MACHINES CORPORATION, Armonk, NY (US)

(21) Appl. No.: 12/947,033

(22) Filed: Nov. 16, 2010

(30) Foreign Application Priority Data
Nov. 26, 2009 (CA) 2686367

(51) Int. Cl. G06F 9/44

(52) U.S. Cl. 717/113

(57) ABSTRACT

A method, computer program product and system for providing for the editing of software code in a software model driven development process, the method including the step of providing a plurality of custom native software code editors each in a different software language. The method, computer program product and system also includes the step of moving one of the plurality of custom native software code editors into a code view display area depending on a user selected element, thereby allowing a user to edit the software code relating to the user selected element using the custom native software code editor moved into the code view display area.

### CROSS-REFERENCE TO RELATED APPLICATIONS

This application claims priority to Canadian Patent Application No. 2686367, filed Nov. 26, 2009, the disclosure of which is incorporated herein by reference.

### BACKGROUND

Various aspects of the present invention relate generally to software model driven development, and more specifically, to the dynamic integration of a plurality of custom domain software code native language editors into a code view façade, thereby providing editing support for the specific user selectable native language utilized at the time of code editing.

In software model driven development (MDD), Unified Modeling Language (Unified Modeling Language) tooling can be used to perform MDD. A benefit of MDD is that users can create and work with platform independent models, i.e., models that are independent of any particular software language, while providing code fragments that allow the model's behavior to be code generated or transformed into a platform dependent domain. That is, a Unified Modeling Language model provides users the ability to model both the structure and behavior of the model. The structure portion of a model is typically platform independent as it describes the high level architecture of how the system being developed will interact. The behavior portion of a model, however, is where the model starts typically getting tied into a specific domain (i.e., software language).

The most recent Unified Modeling Language specification itself is unable to fully represent the entire behavioral aspect of a model. Instead, the Unified Modeling Language specification provides special elements that are intended to contain code fragments that allow a system developer to provide detailed behavior for each platform dependent domain. The Unified Modeling Language element, which can be referred to as “OpaqueElement,” provides the capability to store multiple code fragments, each qualified by a unique language. That is, when the user queries the OpaqueElement with the string name of language “X”, e.g., Java™, the user receives in return, the code fragment written in language “X.” Therefore, system developers are able to provide, for one OpaqueElement, an implementation for multiple languages, e.g., both for Java and C++. Using either the transformation for Java or for C++, the system developer can transform, i.e., generate source code for, their model into their native language of choice, e.g., Java or C++ in this example.

### BRIEF SUMMARY

According to aspects of the present invention, the editing of software code in a software model driven development process includes providing a plurality of custom native software code editors, each in a different software language. The editing of software code also comprises moving one of the plurality of custom native software code editors into a code view display area depending on a user selected element for a user to edit the software code relating to the user selected element using the custom native software code editor moved into the code view display area.

The editing of software code in a software model driven development process may further comprise using an event manager to determine the one of the plurality of custom native software code editors to move into the code view display area.

### BRIEF DESCRIPTION OF THE SEVERAL VIEWS OF THE DRAWINGS

FIG. 1 comprises FIGS. 1A and 1B, and is a display of a Properties View and a Code View in accordance with an embodiment of the present invention;

FIG. 2 is a simplified class diagram of the architectural components of an embodiment of the present invention;

FIG. 3 is a class diagram that illustrates the architecture for an extension point provided by the Code View that allows one to register a language and its corresponding native editor, an EventManager and its filter, if needed, and preference pages that are available from the editor of an embodiment of the present invention;

FIG. 4 comprises FIGS. 4A and 4B, and is a class diagram that illustrates a pattern used to integrate a native editor into the Code View framework in accordance with an embodiment of the present invention;

FIG. 5 illustrates an exemplary XML file for registering into a Code View extension point in accordance with an embodiment of the present invention;

FIG. 6 comprises FIGS. 6A-6E, and illustrates an exemplary Extensible Markup Language Schema Definition (XSD) file for defining a Code View extension point in accordance with an embodiment of the present invention; and

FIG. 7 is a schematic block diagram of a general-purpose computer suitable for practicing embodiments of the present invention.

### DETAILED DESCRIPTION

Embodiments of the present invention provide for a code view “façade” that integrates existing custom domain native editors, such as the C/C++ Development Toolkit (CDT) editor for C++, or the Java Development Toolkit (JDT) editor for Java, into a single display view. In this regard, the code view façade provides specialized support for the specific native language that is important at the time of editing. This Code View approach provides a single point of focus for the user or system developer seamlessly switches between underlying native editors depending on the current language that the user is modeling in. This approach also provides the user or system developer with the rich editor support needed, while also avoiding the unnecessary steps of opening a full-fledged editor, which would otherwise hinder the user's ability to continue using a modeling diagram as context for a code fragment being edited.

Thus, the user is provided with features such as syntax highlighting, content assist, refactoring capabilities, etc., based on the language of the native code the user is currently utilizing. Furthermore, in cases where generated code is available, the code view of embodiments of the present invention allow the user or system developer to edit the generated source code directly, since an actual source editor is being used in the Code View facade. This keeps all changes automatically synchronized between the existing generated code and the model. In cases of C++ editing, where generated code is used in the Code View of embodiments of the invention, the user will typically have access to all library functions, e.g., operating system or third party libraries, which have been included into their generated files, thereby increasing productivity of model driven development system developers.

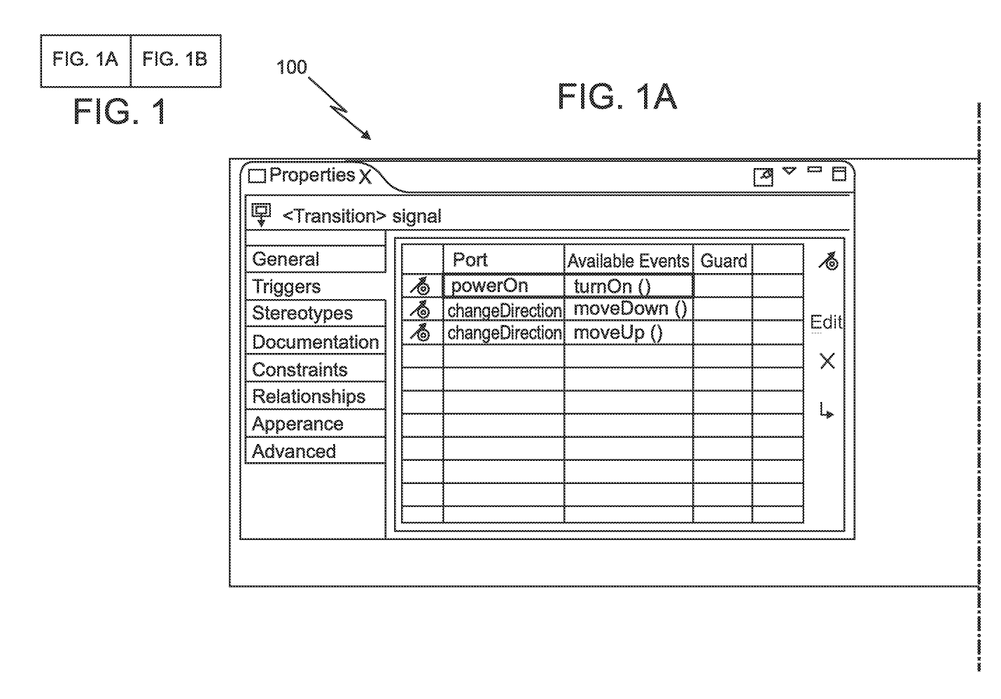

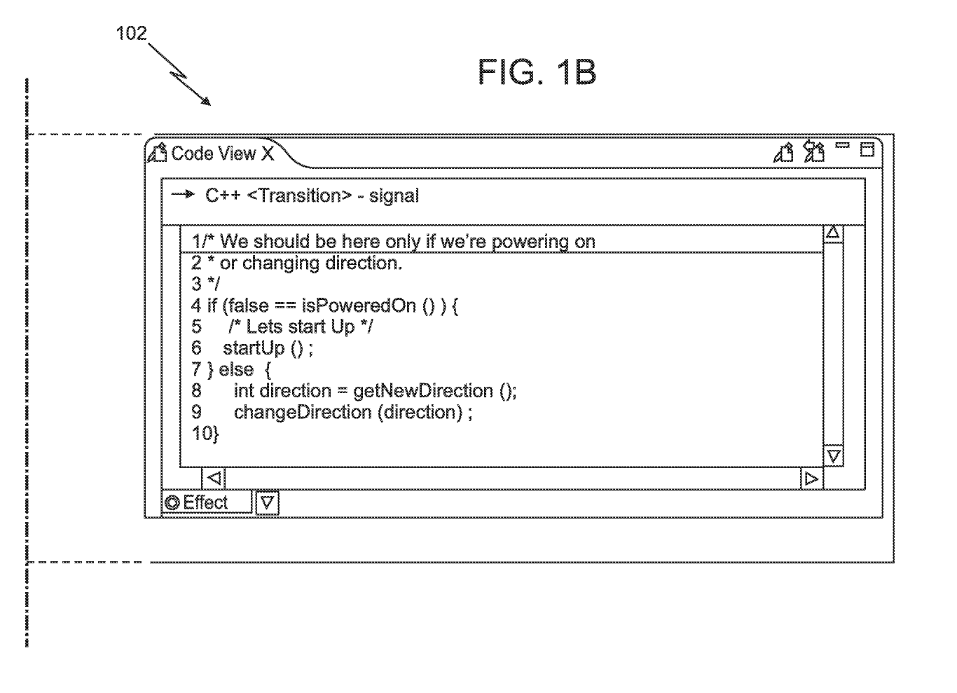

In addition, and with reference to FIG. 1, as the editors may be encapsulated in a view, the element selection on the modeling diagram will not be lost. Thus, users may be able to simultaneously use the “Properties View” 100 (FIG. 1A) of the selected element while writing a code fragment at the same time in the element being edited, as shown in the Code View 102 (FIG. 1B), which is displayed simultaneously with the Properties View 100. For instance, a user may use the properties view 100 to find any internal data that may be needed for writing the code fragments in the Code View 102. Using a docked editor does not accomplish this, as once a selection goes to a standard editor, the Properties View 100 will “blank” itself, as the selection (the editor) is no longer supported.

In an embodiment of the present invention, there are several architectural components utilized. One is the Code View 102, which is responsible for the user interface of displaying the element being edited. The Code View 102 may typically be generic. In an illustrative example, the Code View contains a title bar describing what is being edited, and a tab pane in the event that facilitates editing multiple sub elements based on a selected element. As an illustrative example, a “State” may have “Entry,” “Do,” and “Exit” behaviors that can be edited. The Code View 102 also displays the nested native editor located therein. The Code View 102 keeps a registry of known languages, e.g., Java, C++, etc., and their respective rich native editors. The Code View 102 may also listen to the selection service and respond to the selection changes of the user or system developer.

Another architectural component in the Code View framework of an embodiment of the present invention is an UpdateEditorEvent. An event class is responsible for containing all of the required data that the Code View 102 will need to initialize itself correctly. For example, the event class may contain data that identifies: the language to be used, the editor input to display, the title to display, how the user creates, modifies or deletes an associated element based on the final code snippet when it is saved, and whether there are any user messages to display. An exemplary user message may indicate for example, why an element is not editable. In an embodiment, the UpdateEditorEvent may have a generic implementation, but it may be specialized by each application if extra functionality is required.

Another architectural component in the Code View framework of an embodiment of the present invention is the EventManager, which is responsible for creating UpdateEditorEvents that are passed to the Code View 102. The EventManager may be application specific and is typically implemented by users who desire to make use of the Code View functionality. Thus, typically a plurality of EventManagers exists. The EventManagers may, although not necessarily, each correspond to a language supported by the Code View framework of embodiments of the present invention, depending upon the user's needs. That is, a plurality of EventManagers exist, where each EventManager is associated with a corresponding application domain where a user desires to support code augmentation of model/workspace elements.

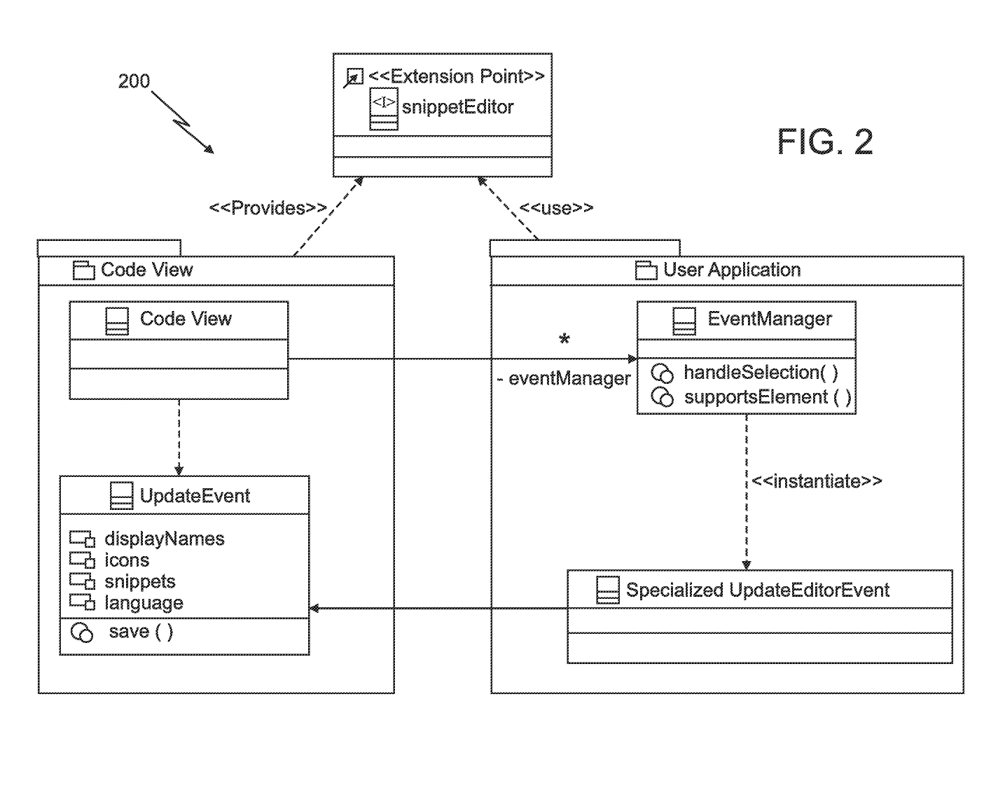

Referring to FIG. 2, a simplified class diagram 200 of architectural components of an embodiment of the Code View framework of the present invention, is illustrated. As illustrated, the Code View framework includes architectural components including an UpdateEditorEvent architectural component and an EventManager architectural component.

An exemplary flow of events is as follows: the user first selects an element in the platform independent model that is being developed using model driven development (MDD). The Code View 102 is notified of the new element selection and queries the plugged in EventManagers to determine who should provide the event. If an EventManager is found, the Code View 102 passes the newly selected element to the located EventManager, and, given that an UpdateEditorEvent is returned, the Code View 102 then allows all registered UpdateEventAdvice to modify the event as needed. The Code View 102 then initializes itself based on the UpdateEditorEvent data. During the Code View initialization, the language to use, e.g., Java, C++, etc., is extracted from the UpdateEditorEvent, and the language is used against its internal registry of supported languages. The initialization will also attempt to find a plugged in native editor that supports the selected language to display in the Code View area 102. If no specialized editor is found, then a generic editor is used in the Code View area 102.

More specifically, the Code View swaps different native editors into the Code View area 102 (FIG. 1B) based on a user selection which itself is based on the language the user is utilizing in the behavior portion of software model driven development. Static editors such as the C/C++ Development Toolkit (C++), the Java Development Toolkit (Java), and others are chosen based on a file extension associated with a file resource. The Code View 102 allows the EventManager to determine the appropriate language to use, e.g., by reading from a workspace preference or by determining a language from a selected element. For example, the Unified Modeling Language element OpaqueBehavior has two lists, one for language names and the other for corresponding bodies.

It is possible that one OpaqueBehavior has only Java code and the other has only C++ code. Selecting the one with the Java code may result in the EventManager stating that Java is the default language and thus a Java Development Toolkit editor is loaded into the Code View 102 and the Java source is extracted from Unified Modeling Language OpaqueBehavior and displayed in the Java Development Toolkit editor in the Code View area 102. If the element with C++ is selected, the C/C++ Development Toolkit editor is loaded and initialized with the C++ source code.

Also, the static C/C++ Development Toolkit and Java Development Toolkit editors require a file resource to exist for them to operate. The Code View framework of embodiments of the present invention, facilitates the use of these types of editors without an underlying resource, by providing a “virtual” input. This allows the user to select model elements that do not have generated source files associated with them yet, but allows the user to edit the source snippet that is associated with the element using a native editor.

According to aspects of the present invention, the Code View framework provides support for a plurality of rich native editors, and further provides seamless integration of the supported native editors, such that the user is provided with the necessary editor, even if the user does not know the proper editor required for a given task. The user can make an educated decision about which language is important (if any) when the user creates anUpdateEditorEvent, and the Code View framework will simply look up the registered rich editor and insert it into the code View 102. In addition, there are a common set of actions that can be contributed across all the domain editors unifying the user experience. For example, actions may include Open Model Element, Launch Source Editor, Launch External Editor, and Find in Model, just to name a few. That is, the user can contribute the actions via the UpdateEditorEvent. Then, regardless of which editor is actually used to display the code, those actions will be available from the context menu.

In addition, the Code View framework of embodiments of the present invention provides an ability to encapsulate multiple elements. For example, a state in the Unified Modeling Language can have Entry, Do and Exit behaviors (opaque behaviors). The Code View framework provides facilities to select the state itself, and have data regarding all elements that should be encapsulated, such as Entry, then Do and the Exit behaviors. It may also encapsulate and provide access to all outgoing and incoming transitions, if desired. This encapsulation allows users to continue to work and think at an abstracted higher level and allows lower level implementation decisions to be hidden from the users.

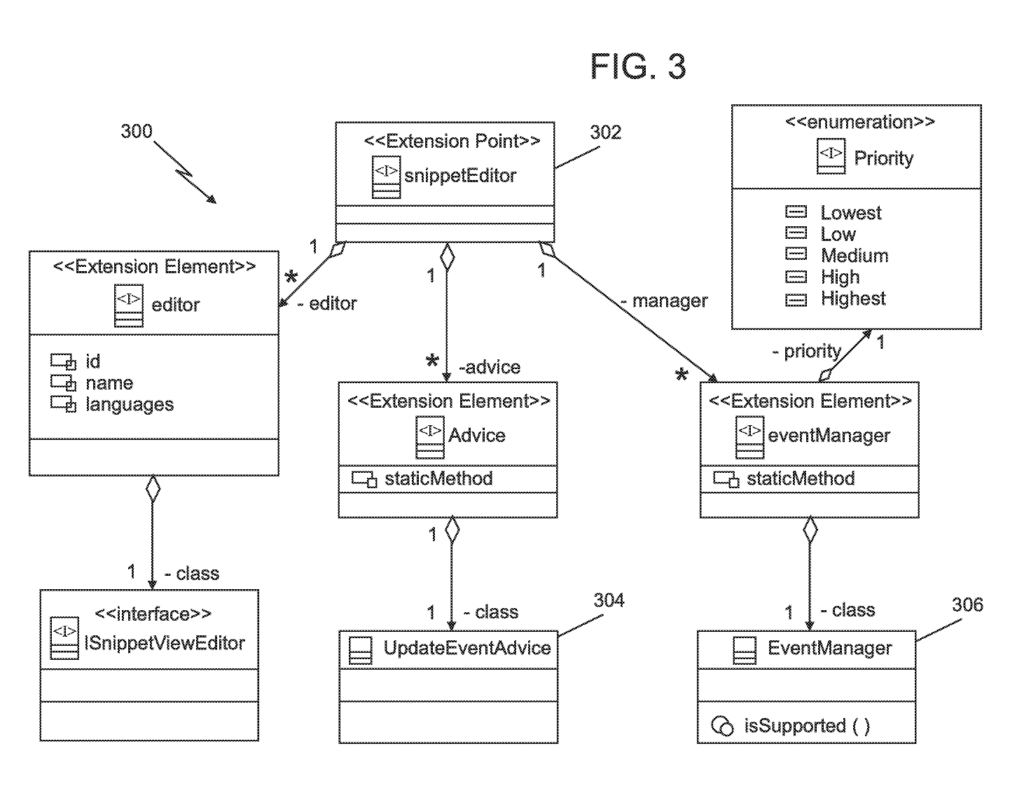

FIG. 3 illustrates the architecture 300 for an extension point provided by the Code View 102 that allows one to register within the Code View framework of embodiments of the present invention, a language and its corresponding native editor, an EventManager and its filter, if needed.

As illustrated, a snippetEditor extension point 302 is utilized by a user to plug in various editors, EventManagers or Update Advice. An extension point definition is simply an Extensible Markup Language Schema Definition (XSD), or more generally, a schema file, which defines the rules to create an Extensible Markup Language (XML) document that can be read in at an initialization time of the Code View 102. A user plugs in to the extension point by defining a file called “plugin.xml” in the user's project. This plugin.xml file identifies the extension points that will be used via xml elements. Then underneath this Extensible Markup Language element is information that further defines what is to be registered with the Code View framework.

However, the pluggable nature of the Code View framework is not limited to using XSD/XML files. When the Code View framework starts and plug-ins of the Code View framework are first loaded, the Code View framework searches the registry for all uses of the defined extension point associated with the Code View framework. For example, the Code View framework may search for all plugin.xml files that have the certain defined extension point. The Code View framework then iterates through these usages, and extracts all information that clients have provided.

UpdateEventAdvice 304 supplements the event managers by performing additional work on the events that have been created by an EventManager 306. If no event manager supports the selected element, then no event will be created and therefore Advice 304 is not involved. However, if an event is created, all plugged-in Advice 304 will have the opportunity to update the newly created event before having it passed to the Code View to initialize the View and Editor.

For example, consider the situation where a user desires to have a generic, reusable, plug-in define the EventManager that creates the events for all Unified Modeling Language elements. In this exemplary situation, assume that Team1 is to be responsible for maintaining the logic needed to create events and support generic Unified Modeling Language elements. Team2 provides a tool built on top of the Unified Modeling Language and provides specialized stereotypes for certain Unified Modeling Language elements. The provided stereotypes are only understood in the context of Team2 plug-ins. By registering UpdateEventAdvice 304 in Team2′s plug-in, reuse of the work done by Team1 is promoted by simply allowing Team 1's EventManager, in the core component, to continue to create the event and support all basic Unified Modeling Language elements. Team2's responsibilities are limited to supporting the specialized logic of checking if the selected object has a Team2 stereotype applied and in which case the UpdateEditorEvent created by Team 1's EventManager will be set as Read-Only (using the API available through the UpdateEditorEvent API).

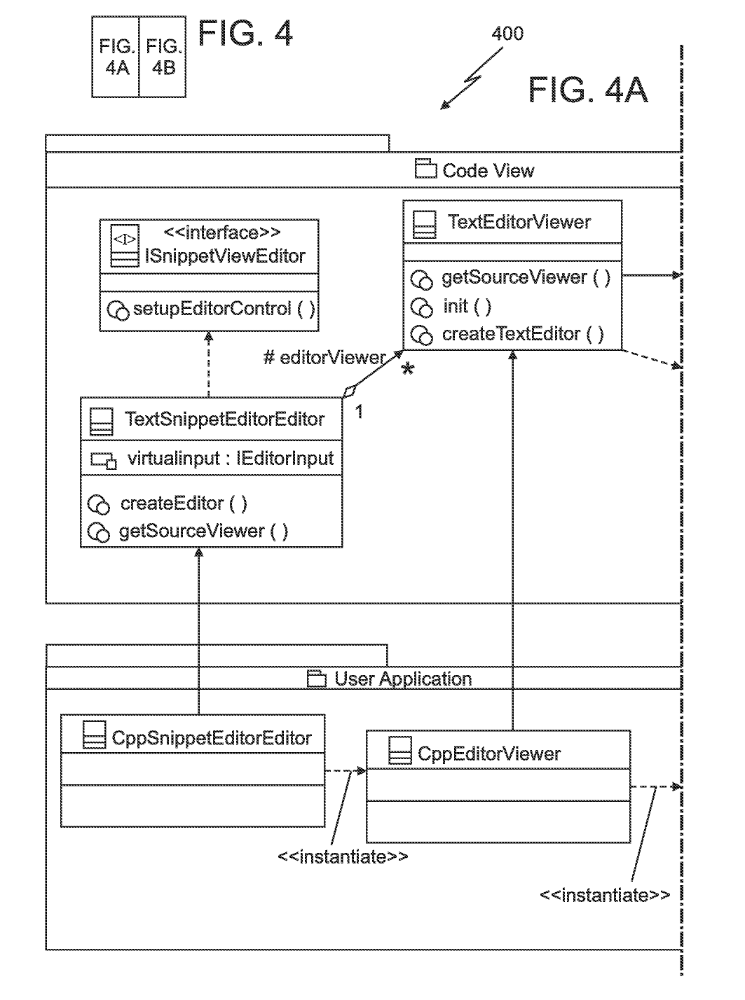

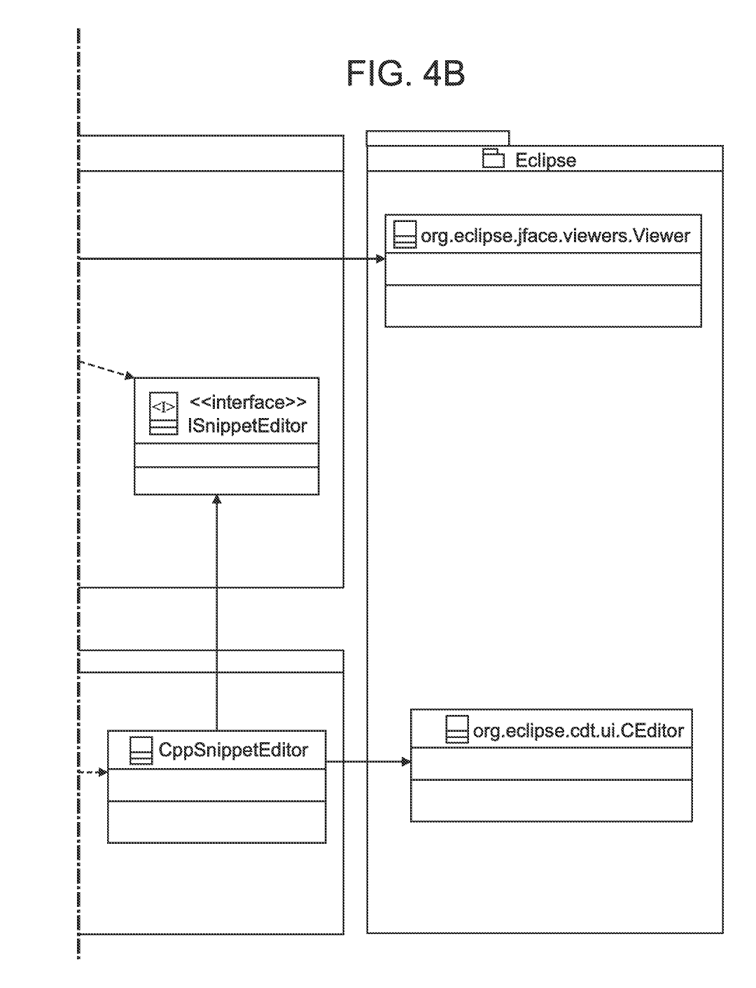

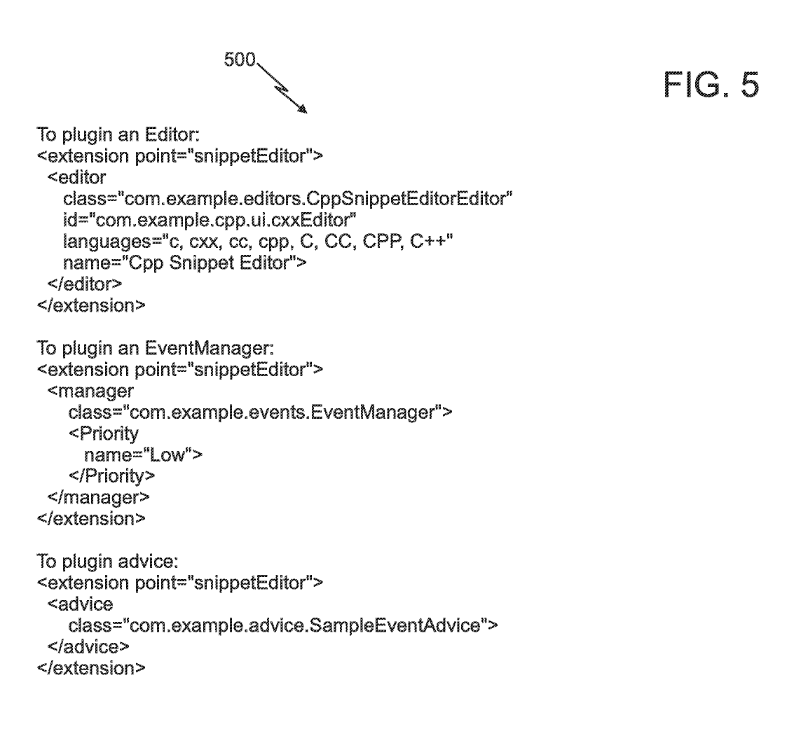

FIG. 4 comprises FIGS. 4A and 4B, and illustrates a pattern 400 used to integrate a native editor into the Code View framework. For a user to plug in an actual editor (e.g., a C++ editor), the following pattern is utilized. Users are required to implement three classes: (1) a TextSnippetEditorEvent; (2) a TextEditorViewer; and (3) an ISnippetEditor.

FIG. 5 illustrates an exemplary XML file 500 for registering into the Code View extension point.

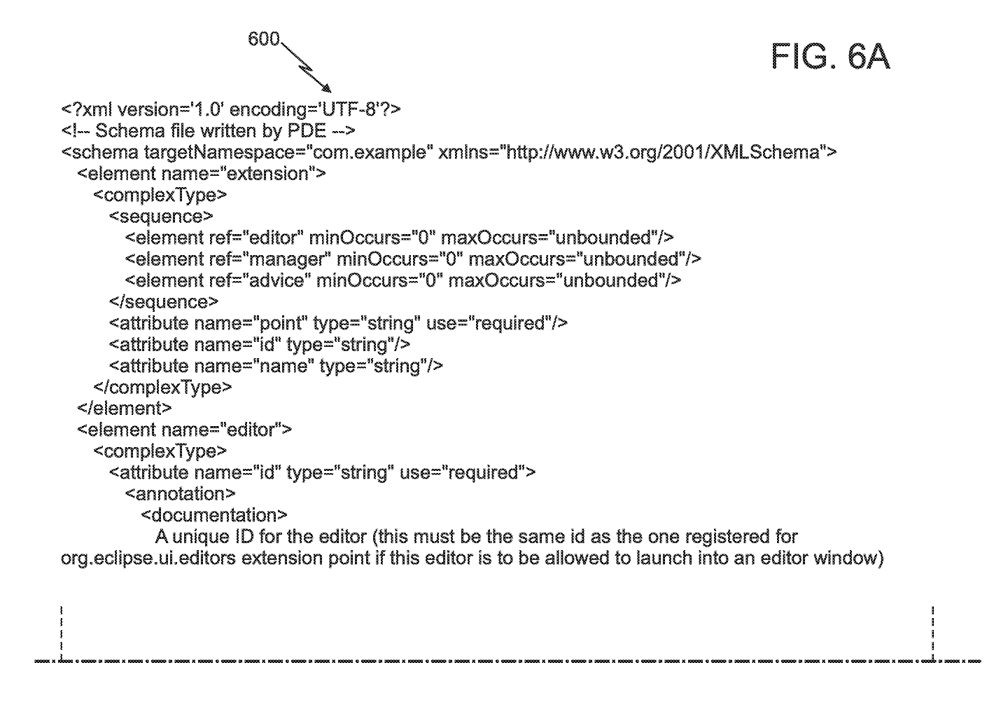

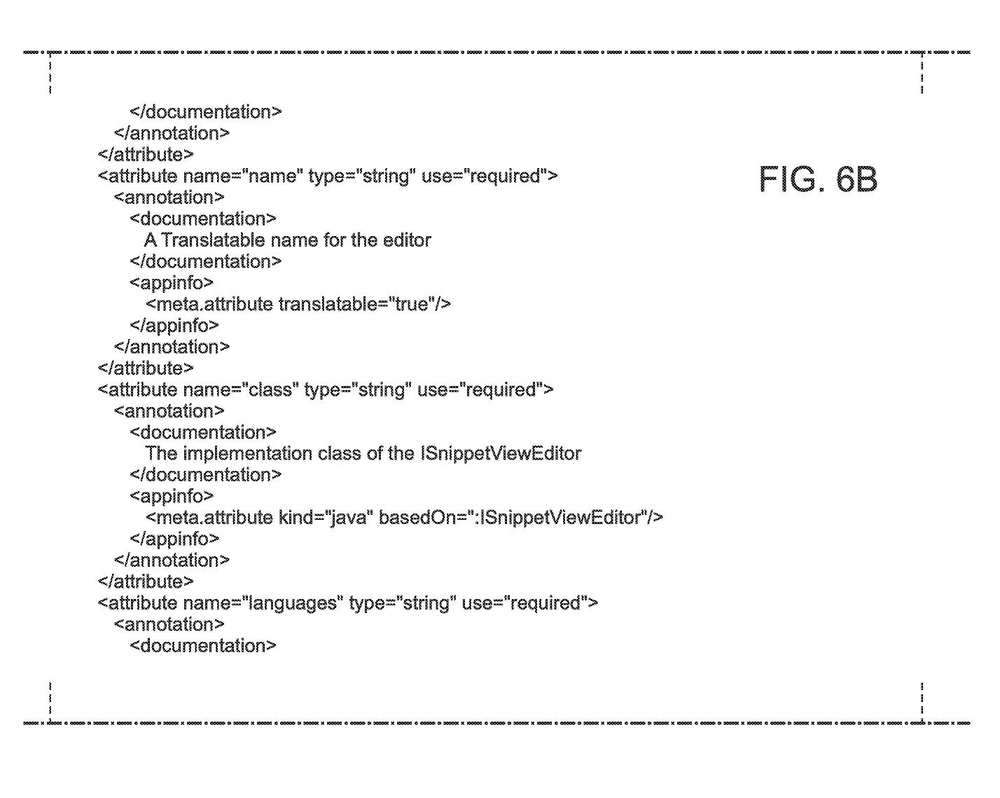

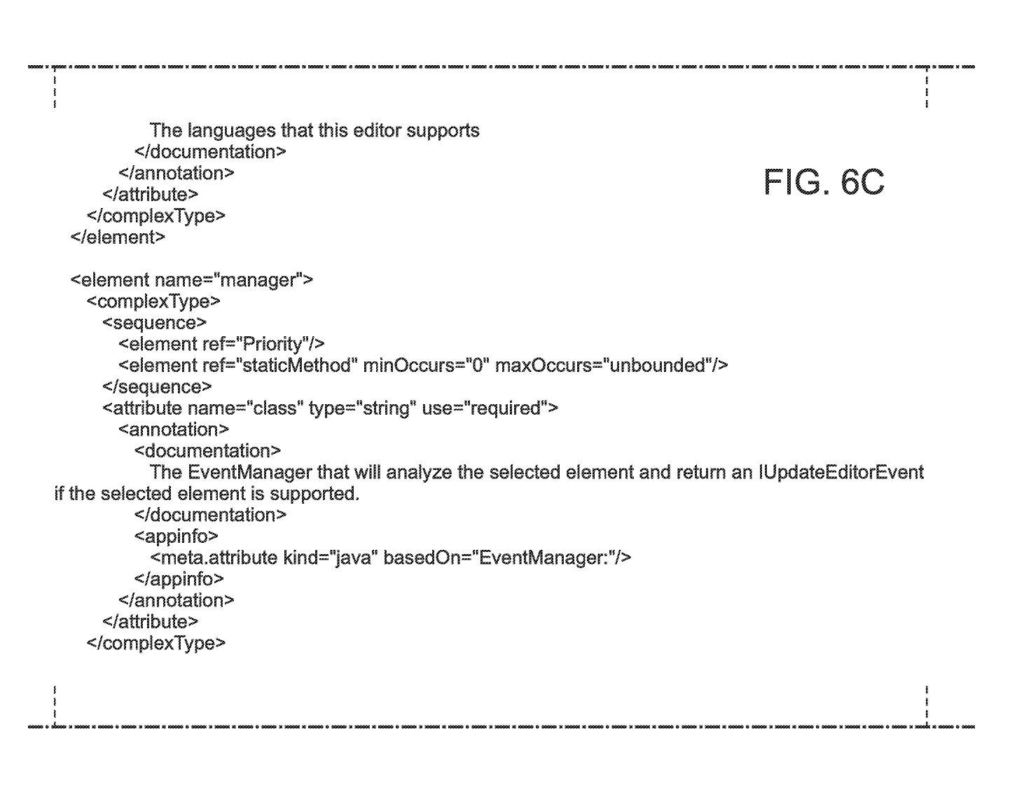

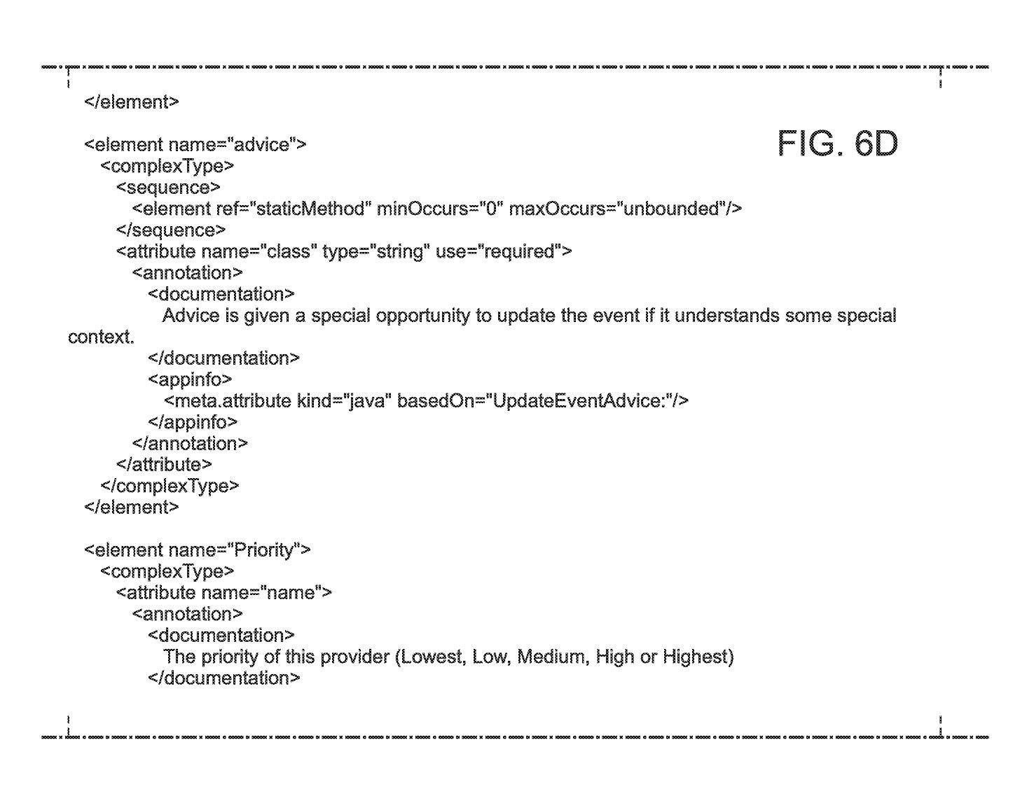

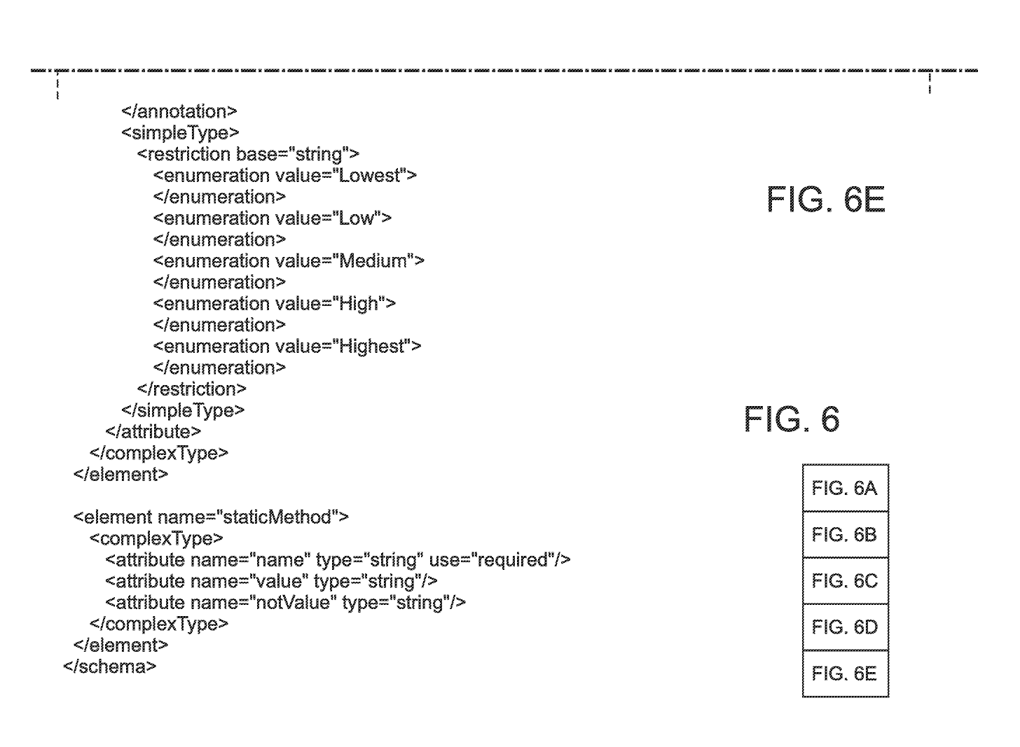

FIG. 6 comprises FIGS. 6A-6E, and illustrates an exemplary XSD file 600 for defining the Code View extension point.

Embodiments of the present invention have been described using either a Java editor or a C++ editors. However, embodiments of the present invention are not limited as such. Any editor may be utilized in various embodiments of the present invention. Other editors include, for example, an Object Constraint Language (OCL) editor, a standard Text editor, a COBAL editor, a FORTRAN editor, an XML editor, and any other type of editor.

Also, the Code View framework of embodiments of the present invention, has been described hereinabove for use in model driven development. However, the present invention is not limited as such. Instead, the Code View framework itself is a generic framework that is not tied to the Unified Modeling Language. Users of other meta-models (i.e., non-Unified Modeling Language) may also use the Code View if needed. Even non-model based applications may use the Code View. For example, when selecting a file, a user may simply populate the Code View to show the file without needing to actually open a full blown editor to see and edit the code. Still further, the Code View framework is not necessarily tied to software development use cases. The nature of the framework allows clients of any kind to utilize Code View to support any selected element (model element or not). The pluggable editors make is seamless for native editors to be swapped into the Code view, in the case that a language specific editor is beneficial for the type of textual input being added against the selected element.

Embodiments of the present invention allow the user or system developer to dynamically and seamlessly select and switch between underlying native editors depending upon the current software language, e.g., Java, C++, etc., that the system developer is using for platform independent modeling within a software model driven development effort. The embodiments also allow for native editors to be used when there is no underlying file resource yet to edit in. Embodiments of the present invention also provide the user or system developer with all the rich editor support needed while also avoiding the unnecessary steps of opening a full fledged editor while performing software model driven development. Embodiments of the present invention further provide for a generic code (text) editor with a base level of functionality when a software language is not determined or understood, and also allow for encapsulation of multiple elements.

For example, assume that a user wants to implement an application to send a message to a hardware console of a device. In this regard, the user may create a transition between two states in a state machine diagram associated with the desired application. Keeping with the current example, assume that there are two types of devices that are expected to run the software. However, one type of device needs the application to be written in Java and the other type of device needs the application to be written in C++.

In this regard, as noted in greater detail herein, embodiments of the present invention provide for a code view “façade” that integrates existing custom domain native editors, such as the C/C++ Development Toolkit editor for C++, and the Java Development Toolkit editor for Java, into a single display view. The code view façade provides specialized support for the specific native language that is important at the time of editing.

The various aspects of the present invention thus avoid shortcomings in the Unified Modeling Language, where the structure of the model is the same, but the behavior of the transition differs in that the transition's OpaqueElement, i.e., the “effect”, will need both the C++ native code and the Java native code to properly generate the source code for the application. For instance, when the model is transformed into a C++application, the C++ code will be extracted from the transition's OpaqueElement for use in the code generation. Conversely, when the Java transform is run, the transform will extract the Java source code from the transition's OpaqueElement. However, in the Unified Modeling Language, the editor used for adding the native code is platform independent as well. As such, the user loses integration with specific language features of a custom native editor, e.g., a Java or C++ editor. Thus, use of the generic Unified Modeling Language code editor may be considered to be a “lowest common denominator” approach, which provides as much functionality as possible to cover any common features needed for multiple languages.

The Code View approach described herein may provide the user with features such as syntax highlighting, content assist, code completion proposals, commenting assist (e.g., providing help for commenting out relatively large blocks of code, adding JavaDocs, etc.), import assist (e.g., to help the user find the proper imports for the classes/files they want to use), code navigation (e.g., navigating to code declarations or definitions, or stepping inside used methods), finding field declarations, and code refactoring (e.g., to assist for renaming variables, methods, fields, or changing method prototypes, etc.), based on the language of the native code the user is currently utilizing. Such features are not available using the Unified Modeling Language code editor.

Further, various aspects of the present invention provide a framework that makes access to custom editor features convenient for a user. Using a conventional UML code editor, it is relatively tedious for a user to access custom editor features. For instance, such access typically requires the user to add “dummy” code and run a transform, which may be relatively time consuming based on the size of the model. The user must then edit the generated source code directly to get the C++ editor features that are currently missing from the current implementation of the UML code editor. The user then must copy the changes and enter them back into the provided UML code editor so that the changes are persisted to the model. Not only must the user perform these steps to be able to edit in a native editor (e.g., C++), but also once the editor is open, the user no longer has access to the UML properties of the element the user is editing, since the user has left the UML model. The user has also lost the view of the UML Model, since the user has opened a full C++ editor. In addition, the user may need to switch back and forth between editors so the user can know the proper contexts of the operations being performed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

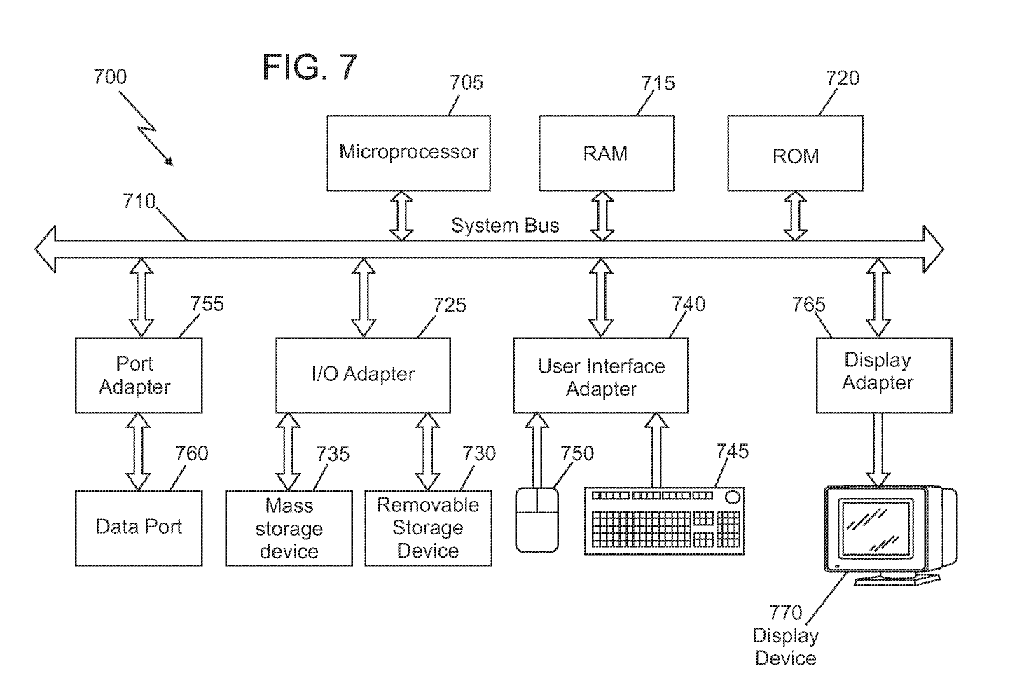

Referring now to FIG. 7, computer system 700 has at least one microprocessor or central processing unit (CPU) 705. The CPU 705 is interconnected via a system bus 710 to a random access memory (RAM) 715 and a read-only memory (ROM) 720. An input/output (I/O) adapter 725 connects a removable data and/or program storage device 730 and a mass data and/or program storage device 735 to the system bus 710. A user interface adapter 740 connects a keyboard 745 and a mouse 750 to the system bus 710. Similarly, a port adapter 755 connects a data port 760 to the system bus 710 and a display adapter 765 connects a display device 770 to the system bus 710.

ROM 720 contains the basic operating system for computer system 700. The operating system may alternatively reside in RAM 715 or elsewhere as is known in the art. Examples of removable data and/or program storage device 730 include magnetic media such as floppy drives and tape drives and optical media such as CD ROM drives. Examples of mass data and/or program storage device 735 include hard disk drives and non-volatile memory such as flash memory. In addition to keyboard 745 and mouse 750, other user input devices such as trackballs, writing tablets, pressure pads, microphones, light pens and position-sensing screen displays may be connected to user interface 740. Examples of display devices include cathode-ray tubes (CRT) and liquid crystal displays (LCD).

A computer program with an appropriate application interface may be created by one of skill in the art and stored on the system or a data and/or program storage device to simplify the practicing of embodiments of the invention. In operation, information for, or the computer program created to run, embodiments of the present invention is loaded on the appropriate removable data and/or program storage device 730, fed through data port 760 or typed in using keyboard 745.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for providing for the editing of software code in a software model driven development process, the method comprising:
providing a plurality of custom native software code editors, each in a different software language; and
moving one of the plurality of custom native software code editors into a code view display area depending on a user selected element for a user to edit the software code relating to the user selected element using the custom native software code editor moved into the code view display area.

2. The method of claim 1, further comprising providing a set of actions that are common to all of the plurality of custom native software code editors.

3. The method of claim 1, wherein moving one of the plurality of custom native software code editors into a code view display area includes displaying the user selected element in the code view display area.

4. The method of claim 1, wherein providing a plurality of custom native software code editors comprises providing at least one of: a Java editor, a C++ editor, an Object Constraint Language editor, a standard Text editor, a COBAL editor, a FORTRAN editor, and an Extensible Markup Language editor.

5. The method of claim 1, further comprising encapsulating a plurality of elements within the code view display area.

6. The method of claim 1, wherein moving one of the plurality of custom native software code editors into a code view display area includes providing an extension point that allows a user to register one of the different software languages and a corresponding one of the plurality of custom native software code editors.

7. A computer program product for providing for the editing of software code in a software model driven development process, the computer program product comprising:
a computer readable storage medium having computer readable program code embodied therewith, the computer readable program code comprising:
computer readable program code configured to provide a plurality of custom native software code editors each in a different software language; and
computer readable program code configured to move one of the plurality of custom native software code editors into a code view display area depending on a user selected element, for a user to edit the software code relating to the user selected element using the custom native software code editor moved into the code view display area.

8. The computer program product of claim 7, further comprising computer readable program code configured to provide a set of actions that are common to all of the plurality of custom native software editors.

9. The computer program product of claim 7, wherein the computer readable program code configured to move one of the plurality of custom native software code editors into a code view display area includes:
computer readable program code configured to display the user selected element in the code view display area.

10. The computer program product of claim 7, wherein the plurality of custom native software code editors includes one of a Java editor, a C++ editor, an Object Constraint Language editor, a standard Text editor, a COBAL editor, a FORTRAN editor, and an Extensible Markup Language editor.

11. The computer program product of claim 7, further comprising computer readable program code configured to encapsulate a plurality of elements within the code view display area.

12. The computer program product of claim 7, wherein the computer readable program code configured to move one of the plurality of custom native software code editors into a code view display area includes:
computer readable program code configured to provide an extension point that allows a user to register one of the different software languages and a corresponding one of the plurality of custom native software code editors.

13. A system, comprising:
a computing network including a processing device in communication with one or more computer memory storage devices,
wherein the processing device is programmed to provide for the editing of software code in a software model driven development process by:
providing a plurality of custom native software code editors each in a different software language; and
moving one of the plurality of custom native software code editors into a code view display area depending on a user selected element, for a user to edit the software code relating to the user selected element using the custom native software code editor moved into the code view display area.

14. The system of claim 13, wherein the processing device is further programmed to provide a set of actions that are common to all of the plurality of custom native software code editors.

15. The system of claim 13, wherein moving one of the plurality of custom native software code editors into a code view display area includes displaying the user selected element in the code view display area.

16. The system of claim 13, wherein the plurality of custom native software code editors includes one of a Java editor, a C++ editor, an Object Constraint Language editor, a standard Text editor, a COBAL editor, a FORTRAN editor, and an Extensible Markup Language editor.

17. The system of claim 13, wherein a plurality of elements are encapsulated within the code view display area.

18. The system of claim 13, wherein moving one of the plurality of custom native software code editors into a code view display area includes providing an extension point that allows a user to register one of the different software languages and a corresponding one of the plurality of custom native software code editors.

19. A method for providing for the editing of software code in a software model driven development process, the method comprising:
providing a plurality of custom native software code editors each in a different software language;
moving one of the plurality of custom native software code editors into a code view display area depending on a user selected element, thereby allowing a user to edit the software code relating to the user selected element using the custom native software code editor moved into the code view display area; and
using an event manager to determine the one of the plurality of custom native software code editors to move into the code view display area.

20. The method of claim 19, wherein moving one of the plurality of custom native software code editors into a code view display area includes displaying the user selected element in the code view display area.

21. The method of claim 19, wherein providing a plurality of custom native software code editors includes providing at least one of a Java editor, a C++ editor, an Object Constraint Language editor, a standard Text editor, a COBAL editor, a FORTRAN editor, and an Extensible Markup Language editor.

22. The method of claim 19, further comprising encapsulating a plurality of elements within the code view display area.

23. The method of claim 19, wherein moving one of the plurality of custom native software code editors into a code view display area includes providing an extension point that allows a user to register one of the different software languages and a corresponding one of the plurality of custom native software code editors.

24. The method of claim 23, wherein providing an extension point comprises providing an extension point that is defined by a schema file that defines rules to create an Extensible Markup Language document that is read in at an initialization time.

25. The method of claim 19, wherein using an event manager to determine the one of the plurality of custom native software code editors to move into the code view display area comprises determining one of the plurality of custom native code editors through use of one of: reading from a workspace preference, or by determining from the selected element.
